(19) United States
(12) Patent Application Publication
(10) Pub. No.: US 2008/0242798 A1
(43) Pub. Date: Oct. 2, 2008

(54) Anti-leaking cartridge and anti-leaking ink

(76) Inventors: Po-Son Wang, Tainan County (TW); Yu-Ting Lin, Taipei County (TW); Yun-I Liu, Hsinchu City (TW); Ming-Chung Peng, Hsinchu (TW); Wen-Chen Liu, Changhua County (TW); Hung-Sheng Hu, Hsinchu City (TW)

Correspondence Address: BIRCH STEWART KOLASCH & BIRCH, PO BOX 747, FALLS CHURCH, VA, 22040-0747, US

(21) Appl. No.: 12/078,015

(22) Filed: Mar. 26, 2008

(30) Foreign Application Priority Data
Mar. 26, 2007 (TW) 96110335

(51) Int. Cl. C08G 67/00

(52) U.S. Cl. 524/612

(57) ABSTRACT

The present invention is generally related to an anti-leaking cartridge and anti-leaking ink. The anti-leaking ink comprises: an organic solvent, which is selected from the group consisting of diethylene glycol, triethylene glycol, triethanolamine amine extra pure, polyethylene glycol 200, and ethylene glycol and functions with at least one seal member for avoiding leakage; at least one dye dissolved in the organic solvent; a buffer solution maintaining the pH value of the anti-leaking ink in between 6.0 to 8.0; an antibacterial avoiding that the properties of the ink is changed; surfactant, which homogenizes the aquas of ink and the organic solvent; and de-ionized water.

### BACKGROUND OF THE INVENTION

1. Field of the Invention

The present invention generally relates to an anti-leaking cartridge and an anti-leaking ink, more particularly to a cartridge that avoids the situation of ink leakage.

2. Description of the Prior Art

The inject printer has being developed for many years and has the merits of lower price, lower noise, good printing quality with full color level, and variable applications with the carriers of plane paper, specific paper, transparent film, etc. The inject printing way is that of an untouchable method, which is to inject ink onto a carrier.

There are three types of inject printers, the first is that of an ink gun installed on a detachable cartridge, such as the brand of Epson. The second is that of the ink gun and the cartridge being detachable to a printer, such as the brand of Canon. The third is that of the ink gun and the cartridge being combined together, such as the brands of HP and Lexmark. No matter what any brand of printer is used, the ink reservoir of a printer basically has a body for accommodating ink and a cover.

With reference to FIG. 1 and FIG. 2, which illustrate a schematic view of relative positions of a cover and a vent hole of a cartridge of U.S. Pat. No. 6,969,165 and a schematic view of the cartridge of U.S. Pat. No. 6,969,165. According to the cartridge 300, the vent hole 138 is an important role. Due to that of related peripherals being not equipped, ink is easily leaked out from the cover while in the situation of changing temperature, pressure, moisture, shaking cartridge, or disposing cartridge upside down. Therefore, to attach the membrane 160 onto the cover of the cartridge can balance the pressure in the cartridge with outside environment, and make some air easily enter into the cartridge in order to drive the ink to go to the ink gun. The membrane 160 is an expanded polytetraflouethylene (PTFE) membrane that is oleophobically treated. It will be appreciated by those skilled in the art that oleophobically treating a porous membrane, such as membrane 160, often involves applying a compound having fluoride atoms to the porous membrane, e.g., a compound having a polyfluoroalkyl group, tryfluoromethyl group, perfluoroalkyl group, or the like, so that the possibility to leak ink is decreased.

Therefore, how to develop a solution to decrease the possibility to leak ink for solving the disadvantages of prior arts is an important issue to the skilled people in the art.

### SUMMARY OF THE INVENTION

Dewatering material is an anti-corrosion material with low surface energy, and can be coated on a porous member, directly made as a porous member, or attached to other materials. Generally speaking, a dewatering and gas permeable material is produced based on the principle of a liquid molecule larger than a gas molecule. Thus, the dewatering and gas permeable function is achieved while the whole diameter of a porous material is smaller than the liquid molecule but larger than the gas molecule. In practice, ink is easily leaked out while in the situation of changing temperature, pressure, moisture, shaking cartridge, or disposing cartridge upside down. The present invention cooperates the ink with the cartridge having the dewatering and gas permeable material; on the other hand, the prior art often applying a compound having fluoride atoms to the porous membrane may no longer need, so as to achieve the purpose of saving cost and the function of avoiding ink leakage.

The primary objective of the present invention discloses a technology of cooperating an ink with a cartridge with a dewatering and gas permeable material. To add some organic solvent having a higher surface contact angle with a dewatering and gas permeable material into the ink can avoid the situation of ink leakage without affecting the property of the ink and printing quality.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of relative positions of a cover and a vent hole of a cartridge of U.S. Pat. No. 6,969,165;

FIG. 2 illustrates a schematic view of the cartridge of U.S. Pat. No. 6,969,165;

FIG. 3 illustrates a schematic view of a preferred embodiment of an anti-leaking cartridge of the present invention; and

FIG. 4 illustrates a schematic view of a top cover of the preferred embodiment of the anti-leaking cartridge of the present invention.

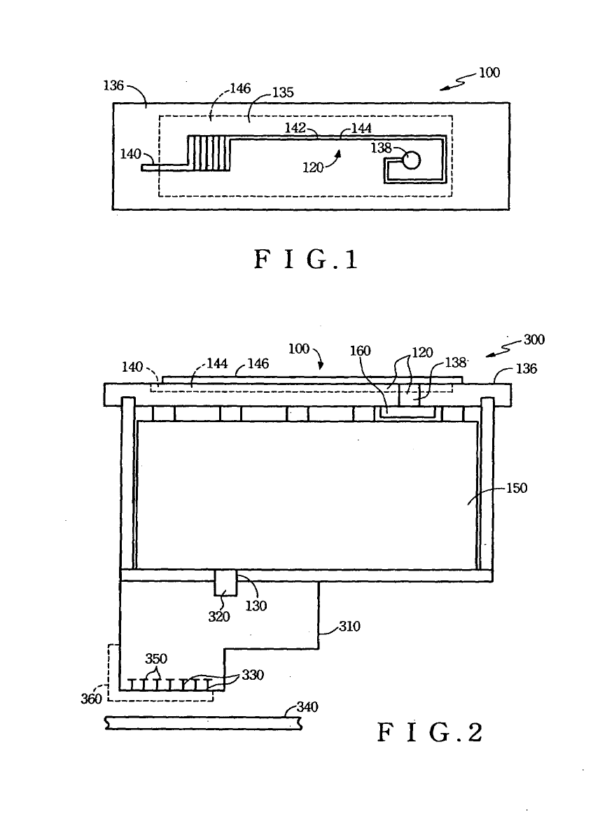

### DETAILED DESCRIPTION OF THE INVENTION

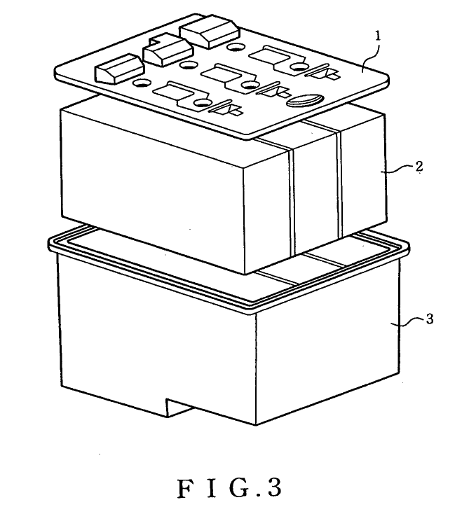

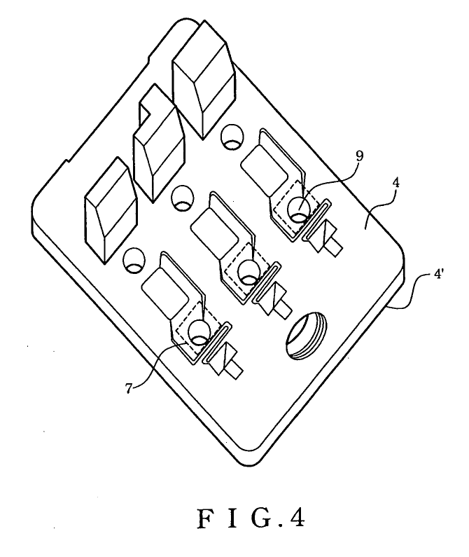

With reference to FIG. 3 and FIG. 4, which illustrate a schematic view of a preferred embodiment of an anti-leaking cartridge of the present invention and a schematic view of a top cover of the preferred embodiment of the anti-leaking cartridge of the present invention. As shown in figures, the anti-leaking cartridge includes a top cover 1, an absorbing member 2, a body 3, a plurality of ventilators 9, a plurality of seal members 7, and anti-leaking ink (not shown in figures); wherein the ventilators 9 are disposed on the surface of the top cover 1 and through the surface in order to let the air enter into the cartridge, then the anti-leaking ink is introduced to pass through an inject head (not shown in figures) for printing work, the absorbing member 2 is disposed in the body 3 and a role of hydrophile macromolecule, the body 3 is an ink tank and uses the absorbing member 2 to hold the anti-leaking ink, the top cover 1 is made by way of injection molding and covered on the body 3, the seal members 7 are attached to the inner surface 4′ of the top cover 1 and made of water-seal material as Teflon to seal the ventilators 9, that is, if the anti-leaking ink is through the ventilators 9 to the outer surface 4 of the top cover 1, and the anti-leaking ink is thus blocked by the seal members 7 so as to avoid the situation of ink leakage. Further that, many different situations may happen in delivery, that is, the cartridge is disposed in an environment with lower pressure or various temperatures of a plane, or severe shake of a ship, etc., and the cartridge can not be assured that the ink leakage may not be avoided, since normal ink may possibly permeate through a lyophobic material. Hence, ink with both invention formula and a lyophobic material can prevent the situation of ink leakage. The anti-leaking ink of the present invention has an organic solvent that contacts an impermeable material in the manner of a high surface contact angle.

The permeable ability of a solution to a small opening is determined by the surface contact angle between the solution and the small opening. The surface contact angle is concluded by the cohesion of the solution and the surface free energy of the small opening. Usually, regarding the same opening, a solution with a larger cohesion has a larger surface contact angle. Hence, by adding some organic solvent having a larger contact angle with an impermeable material, the anti-leaking ink may not over moisten the surface of the seal member 7 while the anti-leaking ink touches the seal member 7. The anti-leaking ink includes: a dye dissolved in the organic solvent; an organic solvent, which is selected from the group consisting of diethylene glycol, triethylene glycol, triethanolamine amine extra pure, polyethylene glycol 200, and ethylene glycol and functions with at least one seal member for avoiding leakage; a buffer solution, which maintains the pH value of the anti-leaking ink in between 6.0 to 8.0 and adjusts the properties of the anti-leaking ink; antibacterial, which avoids that the properties of the ink is changed; surfactant, which homogenizes the aquas of the ink and the organic solvent; and de-ionized water; wherein the organic solvent keeps the anti-leaking ink with more moisture and functions with the seal members for avoiding leakage.

The dye is water-soluble and selected from the group consisting of azo, triaryl, and triphenyl. And the weight percentage of the dye in the anti-leaking ink is 1-20%. The buffer solution is selected from the group consisting of triethanolamine (TEA) and UREA, and its weight percentage is 1-10%; further that, the buffer solution adjusts the chemistry of the anti-leaking ink in order to maintain the pH value of the anti-leaking ink in between 6.0 to 8.0. The antibacterial avoids that the chemistry is changed, and its weight percentage is 1-10%. The weight percentages of the buffer solution and the antibacterial are changeable by the anti-leaking ink. The surfactant homogenizes the aquas of the ink and the organic solvent, and its weight percentage is 1-2%. As a matter of fact, the organic solvent is the major role of normal ink moistening the seal member 7 made of Teflon, and the organic solvent is selected from the group consisting of ethanol, 2-pentanol, N-methyl pyrrolidone (NMP), diethylene glycol, and ethylene glycol. The organic solvent is to dissolve the dye and keep the anti-leaking ink of moisture, and its weight percentage is 10-40%. With reference to table 1, which illustrates average values of the surface contact angle testing the organic solvent on the seal member made by Teflon for five times.

| | | | N-methyl | |
|---|---|---|---|---|
| | ethanol | 2-pentanol | pyrrolidone | 2-pyrrolidone |
| 1 | 36.4 | 41.49 | 68.29 | 70.48 |
| 2 | 38.57 | 42.11 | 68.65 | 70.48 |
| 3 | 37.21 | 39.77 | 68.29 | 69.23 |
| 4 | 36.53 | 39.77 | 68.29 | 72.62 |
| 5 | 34.31 | 38.01 | 68.29 | 71.51 |
| AVG. | 36.604° | 40.23° | 68.362° | 70.864° |

| | | | | triethanolamine | |
|---|---|---|---|---|---|
| | diethylene | triethylene | ethylene | amine | polyethylene |
| | glycol | glycol | glycol | extra pure | glycol 200 |
| 1 | 78.4 | 80.56 | 80.56 | 88.09 | 91.6 |
| 2 | 81.9 | 83.15 | 84.28 | 88.47 | 91.6 |
| 3 | 77.1 | 81.97 | 82.74 | 87.84 | 92.5 |
| 4 | 79.1 | 81.97 | 84.28 | 87.84 | 92.5 |
| 5 | 77.02 | 79.16 | 84.28 | 87.84 | 93.15 |
| AVG. | 78.704° | 81.362° | 83.228° | 88.016° | 92.27° |

The present invention discloses that adding organic solvent having a larger surface contact angle between the surface of the Teflon material and the organic solvent into the ink. For the preferred embodiment, a surface contact angle of some organic solvent and a base material made by Teflon is measured by using phoenix-300. Thus, a surface contact angle of NMP, diethylene glycol, or ethylene glycol and the base material made by Teflon is more than a surface contact angle of ethanol or 2-pentanol about 30 degrees. It is noted that adding ethanol or 2-pentanol into the ink so as to cause that the Teflon base material is more moisture and then the ink may penetrate the Teflon base material. So that the situation of ink leakage is happening.

As a first embodiment, while the ink is added some organic solvent having a larger surface contact angle with the Teflon base material, the organic solvent is as NMP, diethylene glycol, or ethylene glycol. Referring to a second embodiment, while the organic solvent with additional 2-pentanol having smaller surface contact angle is added into the ink. The two kinds of ink with different formulas are separately poured into two cartridges, and a condition is simulated, such as in an airplane or a severe environment, which is under the temperature range of −20˜65° C. and the pressure range of 760-330 mmHg for 168 hours. Hence, from the first and the second preferred embodiments, both happen the situation that the ink is absorbed up to the inner surface of the seal member 7, which is attached to the ventilator 9 of the top cover 1.

With reference to a continuation embodiment of the ink permeating through the upper surface of a dewatering and gas permeable material of the first embodiment under the temperature range of −20˜65° C. and the pressure range of 760-330 mmHg for 168 hours from a microscope and another continuation embodiment of the ink permeating through the upper surface of a dewatering and gas permeable material of the second embodiment under the temperature range of −20˜65° C. and the pressure range of 760-330 mmHg for 168 hours from a microscope. As a result to the continuation embodiment of the first embodiment, the ink does not permeate through from the ventilators 9. As another result to the continuation embodiment of the second embodiment, the ink does permeate through the dewatering and gas permeable material. Hence the anti-leaking ink as an organic solvent can contact an impermeable material or a dewatering and gas permeable material in the manner of a high surface contact angle so as to avoid the situation of ink leakage.

With reference to table 2 and table 3, which illustrate the list of the weight percentages of the preferred embodiment and the list of the weight percentages of the example, and are as following:

TABLE 2

| Ingredient | Weight percentage |
|---|---|
| Food Black 2 | 1-20% |
| N-methyl pyrrolidone | 1-10% |
| diethylene glycol | 1-10% |
| ethylene glycol | 1-10% |
| Biocide | 1-10% |
| Buffer | 1-10% |
| Surfactant | 1-2% |
| DI-water | 55-90% |

TABLE 3

| Ingredient | Weight percentage |
|---|---|
| Food Black 2 | 1-20% |
| 2-pentanol | 1-10% |
| diethylene glycol | 1-20% |
| ethylene glycol | 1-10% |
| Biocide | 1-10% |
| Buffer | 1-10% |
| Surfactant | 1-2% |
| DI-water | 55-90% |

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An anti-leaking ink comprising:
an organic solvent selected from the group consisting of diethylene glycol, triethylene glycol, triethanolamine amine extra pure, polyethylene glycol 200, and ethylene glycol and functions with at least one seal member for avoiding leakage;
at least one dye dissolved in the organic solvent;
a buffer solution maintaining the pH value of the anti-leaking ink in between 6.0 to 8.0;
an antibacterial avoiding that the properties of the ink is changed;
de-ionized water; and
surfactant, which homogenizes the aquas of the ink and the organic solvent;

2. The anti-leaking ink according to claim 1, wherein the dye is water-soluble and selected from the group consisting of azo, triaryl, and triphenyl.

3. The anti-leaking ink according to claim 1, wherein a weight percentage of the dye in the anti-leaking ink is 1-20%.

4. The anti-leaking ink according to claim 1, wherein the buffer solution is selected from the group consisting of triethanolamine (TEA) and UREA.

5. The anti-leaking ink according to claim 1, wherein a weight percentage of the buffer solution is 1-10%.

6. The anti-leaking ink according to claim 1, wherein a weight percentage of the antibacterial is 1-10%.

7. The anti-leaking ink according to claim 1, wherein a weight percentage of the surfactant is 1-2%.

8. The anti-leaking ink according to claim 1, wherein a weight percentage of the anti-leaking ink is 10-40%.

9. The anti-leaking ink according to claim 1, wherein the anti-leaking ink functions with the seal member made by Teflon for avoiding the leakage.
